(19) United States
(12) Patent Application Publication
(10) Pub. No.: US 2024/0158056 A1
(43) Pub. Date: May 16, 2024

(54) KAYAK MOUNT FOR A FISH DETECTION SYSTEM

(71) Applicant: Michael L. Roller, Purdy, MO (US)

(72) Inventor: Michael L. Roller, Purdy, MO (US)

(21) Appl. No.: 18/506,373

(22) Filed: Nov. 10, 2023

Related U.S. Application Data
(60) Provisional application No. 63/425,503, filed on Nov. 15, 2022.

(51) Int. Cl. B63B 34/26; A01K 97/00

(52) U.S. Cl. CPC B63B 34/26; A01K 97/00

(57) ABSTRACT

A mounting bracket for mounting a fish detection system to a kayak. The mounting bracket includes a base configured to be secured to the kayak and a body that extends substantially perpendicular to the base. The body includes a wall that forms a substantially U-shaped hook and a sidewall that forms a substantially L-shaped support along a center line of the wall, wherein the sidewall extends substantially perpendicular to the wall.

### CROSS REFERENCE TO RELATED APPLICATION

This application claims priority to and the benefit of U.S. Provisional Patent Application Ser. No. 63/425,503, entitled “KAYAK MOUNT FOR A FISH DETECTION SYSTEM,” filed Nov. 15, 2022, the contents of which are incorporated herein in their entirety.

### FIELD

This disclosure relates generally to a kayak mount for a fish detection system, and, more particularly, to a bracket to mount a fish detection system including a transducer assembly to a periphery of a kayak.

### BACKGROUND

Fish detection systems assist with detecting fish in lakes and other bodies of water, and provide underwater information such as water depth, distribution of fish, and the condition of the body of water. Many fish detection systems comprise sound navigation and ranging (SONAR) transducers and a corresponding display device. In some systems, the transducer emits signal waves into the water, and segments of the signal waves reflect off of objects (e.g., fish) and travel back to the transducer. The reflected signal waves are recorded, and the location of the fish or other objects may be determined based on the reflected signal waves and displayed on the corresponding display device of the system.

A fish detection system including a transducer assembly can be mounted to a water vehicle, such as a boat or a kayak, so that the transducer assembly can rotate for 360° visibility of the water around the water vehicle. Additionally, the transducer assembly needs to be within reach of an operator of the water vehicle for effective use. Accordingly, there is a need for a bracket to mount a fish detection system including a transducer assembly to a periphery of a kayak.

### BRIEF DESCRIPTION

In one aspect, a mounting bracket for mounting a fish detection system to a kayak is provided. The mounting bracket includes a base configured to be secured to the kayak and a body that extends substantially perpendicular to the base. The body includes a wall that forms a substantially U-shaped hook and a sidewall that forms a substantially L-shaped support along a center line of the wall, wherein the sidewall extends substantially perpendicular to the wall.

In another aspect, a fish detection system is provided. The fish detection system includes a transducer and a mounting bracket configured to mount the transducer to a kayak. The mounting bracket includes a base configured to be secured to the kayak and a body that extends substantially perpendicular to the base. The body includes a wall that forms a substantially U-shaped hook and a sidewall that forms a substantially L-shaped support along a center line of the wall, wherein the sidewall extends substantially perpendicular to the wall.

In yet another aspect, a fish detection system is provided. The fish detection system includes a transducer and a mounting bracket configured to mount the transducer to a periphery of a kayak. The mounting bracket includes a base configured to be secured to the kayak and a body that extends upward substantially perpendicular to the base. The body includes a wall that forms a substantially U-shaped hook and a sidewall along a center line of the wall, wherein the sidewall extends substantially perpendicular to the wall.

### BRIEF DESCRIPTION OF THE DRAWINGS

FIG. 1 is a perspective side view of a mounting bracket having one suitable embodiment.

FIG. 2 is another perspective side view of the mounting bracket shown in FIG. 1.

FIG. 3 is a perspective top view of the mounting bracket shown in FIG. 1.

FIG. 4 is a perspective back view of the mounting bracket shown in FIG. 1.

FIG. 5 is another perspective top view of the mounting bracket shown in FIG. 1.

FIG. 6 is a side view of one embodiment of a transducer assembly of a fish detection system to be used in conjunction with the mounting bracket of FIG. 1.

FIG. 7 is a top view of a portion of the transducer assembly shown in FIG. 6, illustrating a gear assembly of the transducer assembly.

The following detailed description is to be read with reference to the figures, in which like elements in different figures have like reference numerals. The figures, which are not necessarily to scale, depict selected embodiments and are not intended to limit the scope of the present disclosure. Skilled artisans will recognize the examples provided herein have many useful alternatives and fall within the scope of the present disclosure.

### DETAILED DESCRIPTION

The present disclosure is directed to a kayak mount for a fish detection system, and more particularly, to a bracket to mount a fish detection system including a transducer assembly to a periphery of a kayak. The mounting bracket as described herein includes a U-shaped hook body and a base to be attached to a mounting plate on the periphery of the kayak via fasteners. The advantages of the mounting bracket as described herein include at least: (i) mounting a fish detection system including a transducer assembly to the periphery of a kayak for 360° rotational visibility of the water around the kayak; (ii) mounting a fish detection system including a transducer assembly within reach of an operator of a kayak for manual operation of the transducer assembly; (iii) hands-free mounting of a fish detection system to a kayak to allow for operation of the kayak; and (iv) mounting a fish detection system to a kayak with a releasable mount for easy mounting and dismounting of the transducer assembly to the periphery of the kayak.

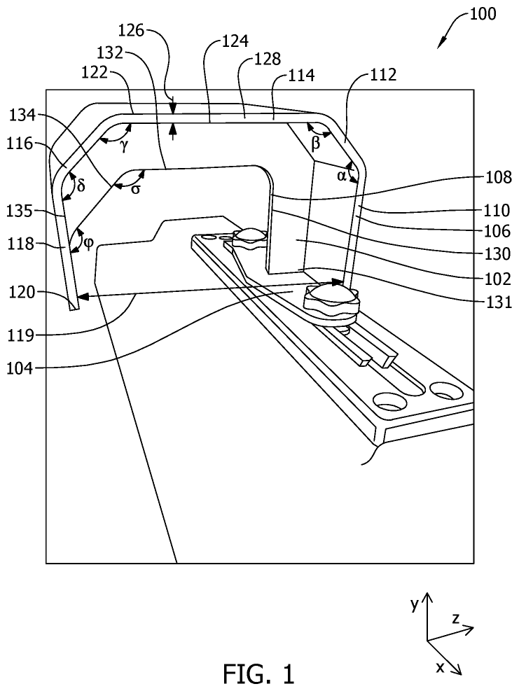

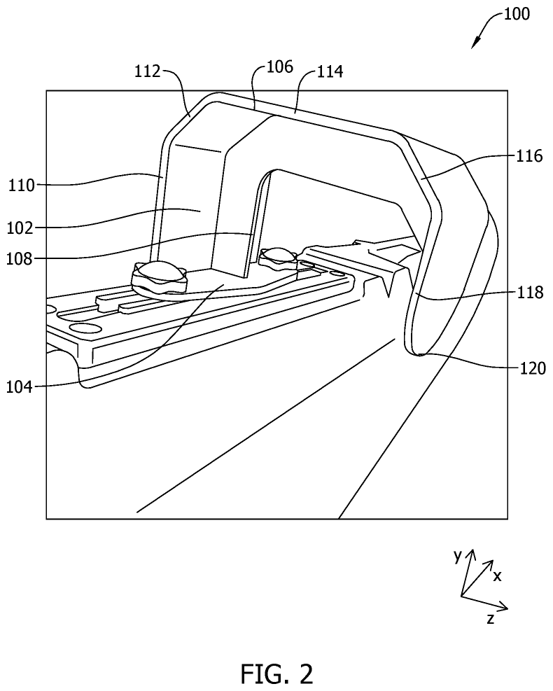

FIGS. 1 and 2 illustrate perspective side views of one suitable embodiment of a mounting bracket, indicated generally at 100, of the present disclosure. The mounting bracket 100 includes a body 102 and a base 104. In the illustrated embodiment, the body 102 extends upward substantially perpendicular to the base 104 at approximately a 90° angle. In some suitable embodiments, the body 102 may extend upward from the base 104 at an oblique angle less than or greater than 90°. In the following description, the base 104 may be described as extending “horizontally,” or along a horizontal plane x-z, and segments of the body 102 may be described as extending “vertically,” or along a vertical direction y. It should be understood that these phrases are descriptive and should not be construed in an overly limiting manner.

The body 102 includes a wall 106 with a plurality of wall segments including a first wall segment 110, a second wall segment 112, a third wall segment 114, a fourth wall segment 116, and a fifth wall segment 118. The wall segments 110, 112, 114, 116, 118 are connected to form a general U-shaped hook. In the illustrated embodiment, the first wall segment 110 extends upward from and substantially perpendicular to the base 104, with the first wall segment 110 extending along the y-plane, that is, vertically. The first wall segment 110 extends from the base 104 at approximately a 90° angle. In some suitable embodiments, the first wall segment 110 may extend from the base 104 at an oblique angle less than or greater than 90°.

In the illustrated embodiment, the second wall segment 112 extends from the first wall segment 110 at an angle α greater than 90°, such that the second wall segment 112 may be described as extending away from the base 104. The third wall segment 114 extends from the second wall segment 112 at an angle θ greater than 90°, extending substantially parallel to the base 104 along the x-z plane, that is, horizontally. The fourth wall segment 116 extends from the third wall segment 114 at an angle γ greater than 90°, such that the fourth wall segment 116 may be described as extending towards the base 104.

In the illustrated embodiment, the fifth wall segment 118 extends from the fourth wall segment 116 at an angle δ greater than 90°, extending substantially parallel to the first wall segment 110 along the y-plane, that is, vertically. The fifth wall segment 118 and the first wall segment 110 form the extensions of the U-shape of the body 102, with a width 119 (as shown in FIG. 1) defined between the first wall segment 110 and the fifth wall segment 118. In some embodiments, the fifth wall segment 118 may taper in slightly towards the first wall segment 110, giving the general U-shaped hook of the wall 106 a non-uniform width across the U-shape between the first wall segment 110 and the fifth wall segment 118, with a narrower width at an open end 120 of the fifth wall segment 118 aligned with the base 104 at the opening “top” of the U-shape. In the example embodiment, the first wall segment 110 terminates and the fifth wall segment 118 initiates at an approximate shared x-z plane across the U-shape.

The junctions between the wall segments 110, 112, 114, 116, 118 of the wall 106 are rounded, with the connections between the wall segments 110, 112, 114, 116, 118 being an arc shape. Additionally, the junctions between the wall segments 110, 112, 114, 116, 118 are smooth due to the monolithic structure of the wall 106, lending to the arc shape of the connections between the wall segments 110, 112, 114, 116, 118. In the example embodiment, the wall 106 includes a first outer surface 122 and a second outer surface 124 opposite the first outer surface 122, in that the first and second outer surfaces 122, 124 define a thickness 126 of the wall 106 that is uniform for all the wall segments 110, 112, 114, 116, 118. The first outer surface 122 and the second outer surface 124 are connected by an edge surface 128 that extends along the thickness 126 of the wall 106.

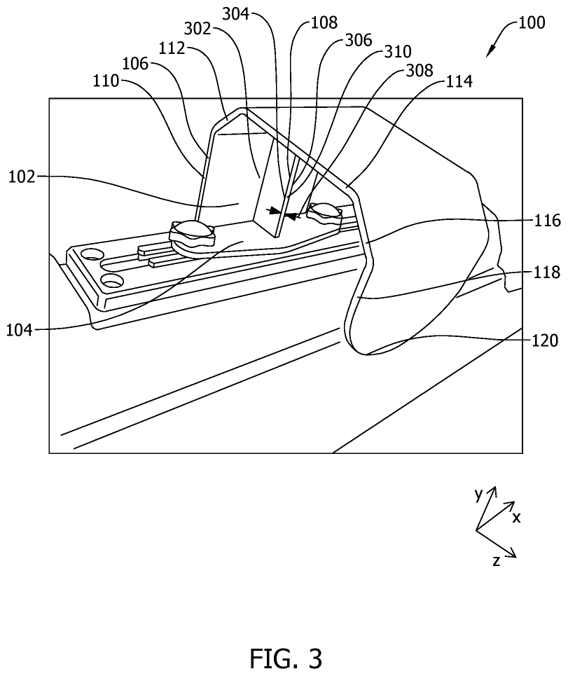

The body 102 also includes a sidewall 108, with the sidewall 108 extending substantially perpendicular to the wall 106 at approximately a 90° angle. In the illustrated embodiment, the sidewall 108 extends from the wall 106 along an approximate center line 302 of the wall 106 (as shown in FIG. 3). In some embodiments, the sidewall 108 may extend from the wall 106 at an oblique angle less than or greater than 90°. The sidewall 108 extends inside the U-shape formed by the wall 106 and has a plurality of side segments, including a first side segment 130, a second side segment 132, and a third side segment 134. The side segments 130, 132, 134 are connected to form a general L-shape, with an end of the L-shape angled upwards.

The first side segment 130 extends from the first wall segment 110, connecting to the base 104 along an initial end 131 of the first side segment 130. The first side segment 130 extends substantially perpendicular to the base 104 along the initial end 131 at approximately a 90° angle. The second side segment 132 extends from the third wall segment 114, with a rounded junction of the first side segment 130 and the second side segment 132 along the second wall segment 112 in a general arc shape. The third side segment 134 extends from the fourth wall segment 116, connecting to the fifth wall segment 118 along a secondary end 135. The second side segment 132 connects to the third side segment 134 at an angle σ greater than 90°, with a rounded junction in a general arc shape. The third side segment 134 extends at the secondary end 135 from the fifth wall segment 118 at an angle φ greater than 90°, with a rounded junction.

FIG. 3 illustrates a perspective top view of the mounting bracket 100. In the example embodiment, the sidewall 108 includes a first side surface 304 and a second side surface 306 opposite the first side surface 304, in that the first and second side surfaces 304, 306 define a sidewall thickness 308 that is uniform for all the side segments 130, 132, 134. The first side surface 304 and the second side surface 306 are connected by a sidewall edge surface 310 that extends along the sidewall thickness 308.

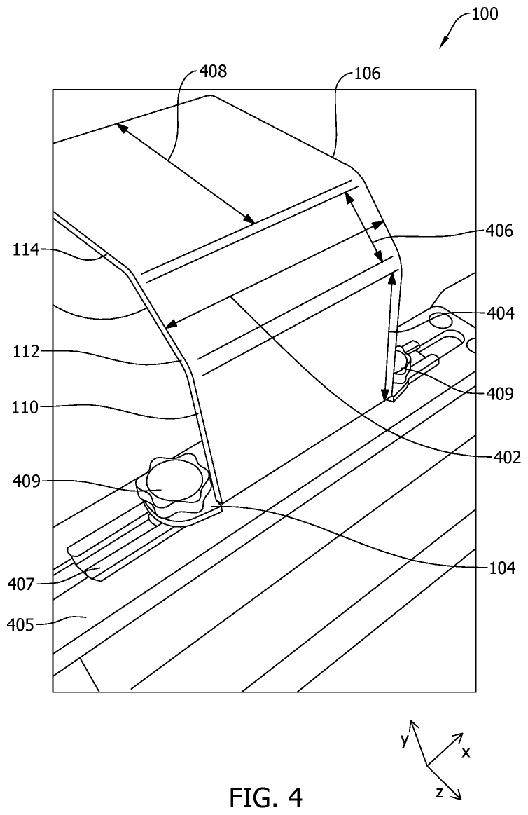

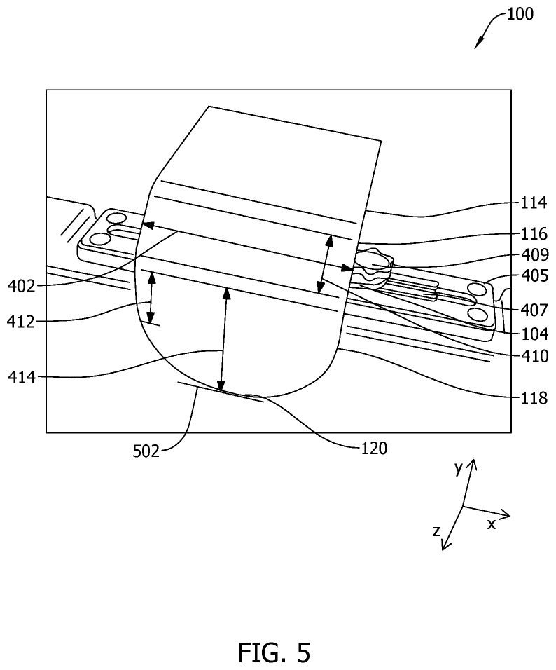

FIG. 4 illustrates a perspective back view of the mounting bracket 100 and FIG. 5 illustrates another perspective top view of the mounting bracket 100. The wall 106 has a width dimension 402. In the example embodiment, the width dimension 402 is uniform for all of the wall segments 110, 112, 114, 116, 118 of the wall 106. Each of the wall segments 110, 112, 114, 116, 118 has a length dimension. As shown in FIG. 4, the length dimensions of the wall segments 110, 112, 114 include a first length dimension 404 of the first wall segment 110, a second length dimension 406 of the second wall segment 112, and a third length dimension 408 of the third wall segment 114. As shown in FIG. 5, the length dimensions of the wall segments 116, 118 include a fourth length dimension 410 of the fourth wall segment 116 and the two length dimensions of the fifth wall segment 118, including a fifth length dimension 412 and a sixth length dimension 414.

The width dimension 402 and the length dimensions of wall segments 110, 112, 114, 116, 118 define general shapes of the wall segments 110, 112, 114, 116, 118. As shown in FIG. 4, the width dimension 402 and the first length dimension 404 form a general square shape of the first wall segment 110, with the width dimension 402 and the first length dimension 404 being substantially the same. The width dimension 402 and the second length dimension 406 form a general rectangular shape of the second wall segment 112, with the width dimension 402 being greater than the second length dimension 406. The width dimension 402 and the third length dimension 408 form a general square shape of the third wall segment 114, with the width dimension 402 and the third length dimension 408 being substantially the same.

As shown in FIG. 5, the width dimension 402 and the fourth length dimension 410 form a general rectangular shape of the fourth wall segment 116, with the width dimension 402 being greater than the fourth length dimension 410. In some embodiments, the general rectangular shapes of the second wall segment 112 and the fourth wall segment 116 are of substantially the same size. The width dimension 402, the fifth length dimension 412, and the sixth length dimension 414 form a general oblong semi-circle shape of the fifth wall segment 118. The width dimension 402 and the fifth length dimension 412 form a general rectangular shape of a top section of the fifth wall segment 118, with the width dimension 402 being greater than the fifth length dimension 412. A bottom section of the fifth wall segment 118 curves to form a semi-circle, with the sixth length dimension 414 measuring to an outer edge of the semi-circle at a tangent line 502 and the width dimension of the bottom section decreasing from the width dimension 402 to the outer edge of the semi-circle.

In some suitable embodiments, the general shapes of the wall segments 110, 112, 114, 116, 118 may be different, based on varying measurements of the width dimension 402 and/or the length dimensions of the wall segments 110, 112, 114, 116, 118. Thus, the width dimension 402 and the length dimensions of the wall segments 110, 112, 114, 116, 118 are not limited to the measurements as described herein or as illustrated in the Figures.

As shown in FIGS. 4 and 5, the mounting bracket 100 is secured to a periphery of a kayak via a mounting plate 405. The mounting plate 405 includes a groove 407 along a length center line of the mounting plate 405 to receive a screw mount (not shown in the Figures) aligned with a bottom end (not shown in the Figures) of a fastener 409. In the example embodiment, the base 104 includes two apertures (not shown in the Figures) that each receive the fastener 409 to secure the mounting bracket 100 to the mounting plate 405. When the base 104 of the mounting bracket 100 is positioned atop the mounting plate 405, the fastener 409 is inserted into and received by each of the two apertures of the base 104, with the bottom end of the fastener 409 threading into the screw mount fitted into the groove 407 to secure the mounting bracket 100 to the mounting plate 405. When secured, the first wall segment 110 of body 102 of the mounting bracket 100 extends substantially perpendicular to the mounting plate 405, with the base 104 of the mounting bracket 100 substantially parallel to and in face-to-face contact with the mounting plate 405. Once secured, the mounting bracket 100 can be used to mount a fish detection system including a transducer assembly to the periphery of the kayak via any mounting method including, but not limited to, an additional bracket, a clamp, and/or a screw.

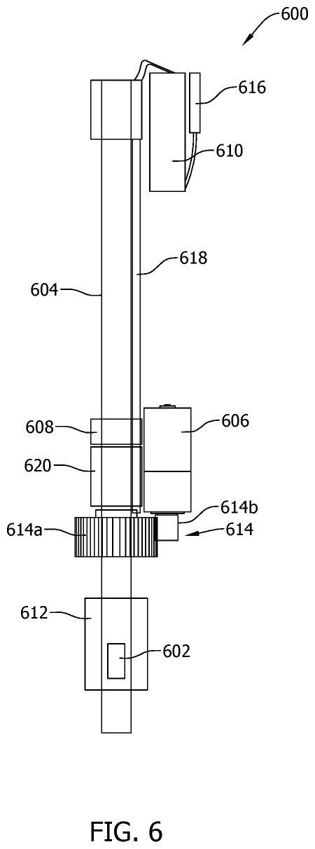

FIG. 6 illustrates an example embodiment of a transducer assembly 600 to be used in conjunction with the mounting bracket 100 of the present disclosure. The transducer assembly 600 includes a transducer 602 configured to provide image information for underwater locations. The transducer 602 transmits and receives signals. In particular, the transducer 602 transmits sonar signals into the water. Objects in the water (e.g., fish) may obstruct the path of the sonar signals transmitted by the transducer 602 and produce reflected signals or echoes in response, which are received by the transducer 602. Although the transducer assembly 600 is shown including one of the transducer 602, any numbers of transducers may be included in the transducer assembly 600. The transducer 602 may be a stock off-the-shelf system, or a custom sonar system. Non-limiting examples of a commercially available system for the transducer 602, for use as part of the transducer assembly 600, include the STRIKER™ fishfinders available from GARMIN®.

The transducer 602 is attached to a shaft 604. In the example embodiment, the transducer 602 is mounted to the shaft 604 of the transducer assembly 600 such that the transducer 602 is positioned underwater in a use position. In addition, the transducer assembly 600 is configured to switch between the use position and a stow position. In some embodiments, the transducer assembly 600 may be attached to a trolling motor (not shown in the Figures) to pivot the shaft 604 relative to a boat with the trolling motor between the use position and the stow position. The depth of the transducer 602 in the water may be adjusted by lowering or raising the shaft 604 and/or the transducer 602 relative to the boat. In other embodiments, the transducer 602 may move independently of the trolling motor (e.g., the transducer 602 may rotate about a longitudinal axis of the shaft 604 and/or relative to the trolling motor) to provide an adjustable field of vision. Therefore, a user may be able to control the boat via the trolling motor and look for objects in the water (e.g., fish) via the transducer 602 independently.

In the illustrated embodiment, an imaging module (not shown in the Figures) of the transducer assembly 600 is in communication with the transducer 602 to process the sonar signals received by the transducer 602 and generate sonar images based on the processed sonar signals. The sonar images are displayed on a display (not shown in the Figures) of the transducer assembly 600, with the display being communicatively coupled with the imaging module to show the determined locations of objects in the water (e.g., fish) on a user interface (such as on a map). The sonar images shown on the display are associated with the underwater environment, depicting the location of the underwater objects that obstruct the sonar signals and produce the reflected signals received by the transducer 602.

The transducer assembly 600 also includes a motor 606 coupled to the shaft 604 and/or the transducer 602 and configured to rotate the shaft 604 and/or the transducer 602. In the example embodiment, the motor 606 is connected to the shaft 604 via a connector 608. In some embodiments, the motor 606 may be controlled by a wireless remote control device (not shown in the Figures), such as a foot control switch (e.g., a pedal) and/or a handheld remote that is communicatively coupled to the motor 606 and configured to receive user input. The motor 606 may be communicatively coupled to the wireless remote control device wirelessly via Bluetooth, near-field communication, Wi-Fi, or any other wireless communication methods known in the art. In the example embodiment, the motor 606 is an electric motor and is configured to receive power from a battery 610.

The transducer assembly 600 also includes a transducer mount 612 coupled to the shaft 604. In the example embodiment, the transducer 602 is attached to the transducer mount 612, which is supported on the shaft 604 by a plurality of gears 614. The transducer assembly 600 further includes a processor 616 mounted to the battery 610, with the battery 610 being attached to the shaft 604 via the connector 608. The battery 610 is configured to provide power for one or more components of the transducer assembly 600 during operation. In the example embodiment, the battery 610 is attached to and configured to provide power to the motor 606 and the transducer 602, with a shielded umbilical 618 extending along the shaft 604 to connect the battery 610 to the motor 606 and the transducer 602. The battery 610 enables the transducer assembly 600 to be self-powered such that the transducer assembly 600 does not rely on power from the boat or systems on the boat. In addition, the battery 610 simplifies installation of the fish detection system and facilitates the fish detection system being compatible with a greater number of boats or trolling systems because the fish detection system does not necessarily require external power sources or specialized power connections.

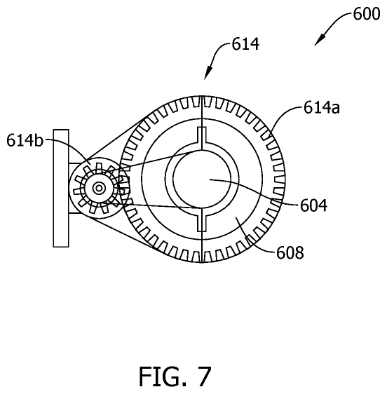

FIG. 7 illustrates a top view of a portion of the transducer assembly 600. In the example embodiment, the plurality of gears 614 are coupled to the shaft 604. The plurality of gears 614 includes a first gear 614a encompassing the shaft 604 and a second gear 614b mounted on the motor 606. The motor 606 is configured to turn the second gear 614b, which in turn travels about the circumference of the first gear 614a, and the shaft 604. Accordingly, the motor 606 is configured to rotate, via the second gear 614b, the transducer 602 around the shaft 604. In some embodiments, the transducer 602 may be configured to rotate 360°. In the example embodiment, the transducer assembly 600 also includes a radial position digitizer 620 (shown in FIG. 6) to detect the positioning of the shaft 604, the motor 606, and/or the transducer 602, and provide the detected positioning information to, for example, the wireless remote control device (not shown in the Figures).

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the disclosure, it is intended that all matter contained in the above description and shown in the accompanying drawings shall be interpreted as illustrative and not in a limiting sense.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mounting bracket for mounting a fish detection system to a kayak, the mounting bracket comprising:
a base configured to be secured to the kayak; and
a body that extends substantially perpendicular to the base, wherein the body comprises:
a wall that forms a substantially U-shaped hook; and
a sidewall that forms a substantially L-shaped support along a center line of the wall, wherein the sidewall extends substantially perpendicular to the wall.

2. The mounting bracket of claim 1, wherein the base is configured to be secured to a periphery of the kayak.

3. The mounting bracket of claim 2, wherein the base is configured to be secured to the periphery of the kayak by one or more fasteners.

4. The mounting bracket of claim 1, wherein the body is configured to be joined with a transducer assembly of the fish detection system to mount the fish detection system to the kayak.

5. The mounting bracket of claim 1, wherein one or more junctions in the wall forming the substantially U-shaped hook are rounded.

6. The mounting bracket of claim 5, wherein the wall comprises a plurality of wall segments, and wherein the junctions in the wall are between adjacent wall segments.

7. The mounting bracket of claim 1, wherein the wall comprises a plurality of wall segments, the plurality of wall segments comprising a proximate wall segment joined to the base of the mounting bracket at a wall join.

8. The mounting bracket of claim 7, wherein the plurality of wall segments further comprises a distal wall segment comprising a curved end at an opposite end of the substantially U-shaped hook from the wall join.

9. The mounting bracket of claim 1, wherein the base comprises a mounting plate, the mounting plate comprising a groove to receive one or more fasteners to secure the base to the kayak.

10. The mounting bracket of claim 9, wherein the mounting plate extends substantially parallel to and in face-to-face contact with the base.

11. A fish detection system comprising:
a transducer; and
a mounting bracket configured to mount the transducer to a kayak, the mounting bracket comprising:
a base configured to be secured to the kayak; and
a body that extends substantially perpendicular to the base, wherein the body comprises a wall that forms a substantially U-shaped hook and a sidewall that forms a substantially L-shaped support along a center line of the wall, wherein the sidewall extends substantially perpendicular to the wall.

12. The fish detection system of claim 11, wherein the base is configured to be secured to a periphery of the kayak.

13. The fish detection system of claim 12, wherein the base is configured to be secured to the periphery of the kayak by one or more fasteners.

14. The fish detection system of claim 11, wherein one or more junctions in the wall forming the substantially U-shaped hook are rounded.

15. The fish detection system of claim 14, wherein the wall comprises a plurality of wall segments, and wherein the junctions in the wall are between adjacent wall segments.

16. The fish detection system of claim 11, wherein the wall comprises a plurality of wall segments, the plurality of wall segments comprising a proximate wall segment joined to the base of the mounting bracket at a wall join.

17. The fish detection system of claim 16, wherein the plurality of wall segments further comprises a distal wall segment comprising a curved end at an opposite end of the substantially U-shaped hook from the wall join.

18. The fish detection system of claim 11, wherein the base comprises a mounting plate, the mounting plate comprising a groove to receive one or more fasteners to secure the base to the kayak.

19. The fish detection system of claim 18, wherein the mounting plate extends substantially parallel to and in face-to-face contact with the base.

20. A fish detection system comprising:
a transducer; and
a mounting bracket configured to mount the transducer to a periphery of a kayak, the mounting bracket comprising:
a base configured to be secured to the kayak; and
a body that extends upward substantially perpendicular to the base, wherein the body comprises a wall that forms a substantially U-shaped hook and a sidewall along a center line of the wall, wherein the sidewall extends substantially perpendicular to the wall.
